(19) United States
(12) Patent Application Publication
(10) Pub. No.: US 2003/0108336 A1
(43) Pub. Date: Jun. 12, 2003

(54) Commercial insert feature

(75) Inventor: Johannes Peter Schramel, Vienna (AT)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/308,657

(22) Filed: Dec. 3, 2002

(30) Foreign Application Priority Data
Dec. 7, 2001 (EP) 01 000 725.0

(51) Int. Cl. H04N 5/781

(52) U.S. Cl. 386/95; 386/125

(57) ABSTRACT

The invention relates a method and a device for the recording and reproduction of signals (S), in particular video signals, comprising insert features (W), in particular commercial insert features, with at least one storage device (5) for the signals (S) and the insert features (W) and at least one device (6) for the automatic recognition of the insert features (W), and furthermore with a storage device (7) for parameters which may be assigned to certain insert features (W), with a checking and control unit (8) for checking the parameters assigned to the recognized insert features (W), and with a device (9) for the automatic selective skipping of those recognized insert features (W) which are assigned certain parameters.

The invention relates to a method of recording and reproducing signals, in particular video signals with insert features, in particular commercial insert features, with the insert features being automatically recognized.

The invention also relates to a recording and reproduction device for the signals, in particular for video signals, with insert features, in particular commercial insert features, with at least one storage device for the signals and insert features and at least one device for the automatic recognition of the insert features during the recording or the reproduction of the signals.

The invention relates in particular to recording and reproduction methods such as those used, for example, with video recorders, DVD (digital versatile disk) recorders, hard disk recorders, and similar recording and reproduction devices. The signals to be recorded and reproduced are in particular video signals, which on the one hand contain the actual useful signal, such as, for example, a feature film, but which also contain insert features, in particular commercial insert features. To finance, for example, television broadcasting stations, the percentage of insert features, in particular commercial insert features, will become increasingly higher. Commercial insert features in this quantity find little acceptance among end consumers. For this reason, devices are known which recognize commercial insert features and automatically skip them during the reproduction of the video signal. For example, U.S. Pat. No. 5,987,210 A describes a method and a device for the blending out of advertizing blocks, which takes place automatically during the reproduction of a recorded video signal but, to avoid faulty recordings, not during the recording. Here, during the recording of the signal, a recognition signal is detected and the times of the recognitions are stored, so that during the reproduction of the video signal the flagged sequences may be skipped. During the skipping, the picture is switched to a blue picture, the sound is switched off, and fast forward is selected on the video recorder.

The automatic recognition of insert features, for example of advertizing blocks, may take place through recognition of overlaid company logos, of certain characteristics of the signal, or on the basis of scene change frequencies.

Since the insert features are used in particular to finance information and service providers, skipping processes and skipping devices of this type mean that they no longer reach their target group, so that advertizers with insert features of this type are not forthcoming, and hence information and service providers of this type will not receive the finance.

The object of the invention is to create a method of recording and reproducing signals by means of which selectively determined insert features, in particular commercial insert features, may be offered to the end user such that this user is not showered with an excessive number of insert features. In addition, the method is intended to secure the financing of information and service providers by means of insert features of this type.

Another object of the invention consists in the creation of a recording and reproduction device for signals, in particular for video signals, by which insert features, in particular commercial insert features, may be selectively offered to the end user and hence an incentive may be created for the originator of the insert features to finance the information and service provider or the manufacturer of the recording and reproduction devices.

The object of the invention as far as the method is concerned is achieved in that parameters are assigned to the recognized insert features, on the basis of which the insert features are selectively skipped. In this way, insert features from service providers or the like which meet specific conditions, for example provide financial support to the television station, may be flagged by assignment of parameters, thus preventing the automatic skipping of insert features of this kind. This guarantees to the provider of the insert features that the end user will also be transmitted insert features, for example commercial insert features. The assignment of the parameters may take place from different viewpoints. For example, it is possible that an end user, for example, may be charged different purchase prices for the recording and reproduction of a film subject to costs, and that the incorporated insert features are assigned specific parameters in dependence upon the purchase price. In this way, an end user paying the highest purchase price, for example, may be offered the film without any insert features, while an end user, who pays a relatively low purchase price will have to accept the inserted commercials or the like. In return for this, the company from which the insert features originate will finance the difference with the higher purchase price of the film. The selective skipping of the insert features may take place during the recording of the signals, during the reproduction, or even during times when the device is not in use, for example in the standby mode.

Here, the parameters assigned to the recognized insert features are preferably alterable, so that the situation may be adapted to the circumstances in question.

In addition, the selective skipping of the insert features may take place in dependence on the current time. This will make it possible to play different insert features at certain times of the day or on certain days of the week, or to permit the skipping of certain insert features on certain days of the week or at certain times.

The selective skipping of the insert features may also take place in dependence on the relative time of the reproduction, so that, for example, when an end user pays a higher purchase price, the insert features at the beginning and end of the film are permitted and only the interposed insert features are skipped.

In accordance with another feature of the invention, it is provided that any repetitions of sections of the signal recorded or reproduced before the insert features are automatically skipped after the insert features together with the insert features. Frequently, certain scenes of a feature film or similar are repeated after advertizing blocks in order to remind the customer of them after the time taken up by the advertising block, so that the customer does not lose the plot of the film or similar. If an insert feature is selectively skipped, such a repetition of the signal or video signal would be unnecessary and even confusing to the end user. The recognition of repetitions of this kind may take place by means of the intermediate storage of the signals and comparison of certain image sections, or alternatively by means of a comparison of audio signals.

The automatic recognition of the insert features may take place during the recording of the signals. However, it is alternatively possible for this recognition only to take place during the reproduction of the signals, although this would require the intermediate storage of the signals.

As was noted above, the automatic recognition of the insert features may take place by image recognition, for example using the logos of certain companies, or by means of typical changes to the image during commercial insert features of this kind or the like.

Alternatively or in addition to this, the recognition of the insert features may also take place by means of the evaluation of the audio signal.

In addition, the recognition of the insert features may also take place by means of the evaluation of the data in the signals.

In addition, it is possible that the insert features are assigned unique identifications on the basis of which they are recognized.

In order, for example, to move the insert features arranged within a film to another time, for example to the beginning or end of the film, it is expedient to store selectively skipped insert features temporarily and reproduce them at a different time. In this way, it is also possible, for example, to reproduce the insert features of certain companies several times during the reproduction of the signal. In addition, it is also possible to couple the reproduction of the inserts to the signal, in which for example certain insert features are reproduced at suitable points of the feature film or similar. For example, the appearance of a car of a certain make may be followed by a commercial insert feature for this make of car, or the reproduction of a certain piece of music may be automatically followed by a commercial insert feature from a music publisher. This will increase the acceptance of insert features of this kind by the end user and increase the benefit from insert features of this kind.

In addition, apart from the programmed insert features, it is also possible to play additional insert features during the reproduction of the signals. These additional insert features will be stored beforehand on a suitable storage medium.

In addition, it is of advantage if these additional inserts are alterable, so that they may be adapted to the time of reproduction. This would also enable signal recordings with an older date to be provided with more up-to-date insert features, for example commercial insert features, concerning current products or services.

For the purpose of subsequent accounting and also for statistical purposes, it is of advantage if the number and type of the insert features and any additional insert features are acquired and stored during the reproduction of the signals. In this way, the manufacturer of insert features of this type may be notified of the true number of reproduced insert features or even the corresponding amount of the payment by the advertiser or similar.

The object of the invention is also achieved by means of a recording and reproduction device for signals, in particular for video signals with insert features, in particular commercial insert features, with at least one storage device for the signals and insert features and at least one device for the automatic recognition of the insert features, which is also provided with a storage device for parameters which may be assigned to certain insert features, with a checking and control unit for checking parameters assigned to the recognized insert features, and in addition with a device for the automatic selective skipping of the recognized insert features which are assigned certain parameters. A recording and reproduction device of this type may, for example, be implemented as a conventional video recorder with magnetic tapes or alternatively as a DVD (digital versatile disk) recorder, or by a hard disk recorder. As soon as an insert feature has been recognized in a way which is known per se during the recording or reproduction of the signals, the checking and control unit checks any parameters assigned to the recognized insert features, following which these recognized insert features are skipped, or are not skipped, during the reproduction. For example, in the event of the financing of the recording and reproduction device by a certain company, a certain parameter may be assigned to the insert features of this company preventing the manual skipping of this insert feature by the user. This will guarantee that the company's insert features will be reliably reproduced and achieve the corresponding benefit for the company. Here, the automatic recognition of the insert features may take place during the recording or the reproduction of the signals or even during times when the device is not in use in the standby mode. The automatic selective skipping of the recognized insert features may also take place during the recording or during the reproduction of the signals.

Advantageously, an input device may be provided on the recording and reproduction device for inputting the parameters enabling these to be altered. Here, the input of the parameters must be suitably protected so that the end user is unable to skip certain insert features. However, the input of parameters of this type may be used to select certain variants of insert features. In this way, the end user may, for example, choose between different categories of advertizing offered. The input device may, for example, be formed by the remote control of the video recorder.

Advantageously, a time unit is provided which is connected to the device for skipping the recognized insert features, so that the time-selective skipping of insert features, for example in dependence on the current time or the day of the week, may also take place. It is also possible to perform the skipping of the insert features in dependence on the relative time, for example of the feature film.

To prevent signal sections of this type played before insert features and repeated after the reproduction of insert features being reproduced twice when the insert features are skipped, in accordance with another feature of the invention, a device is provided for the recognition of those signal sections before the insert features which are repeated after the insert features, and a device is provided for the automatic skipping of these recognized signal sections.

Here, the recognition of the insert features on the one hand and also the recognition of the repeated signal sections on the other may be formed by image recognition devices and/or audio recognition devices and/or data evaluation devices.

If a storage device for the intermediate storage of insert features is provided, a multiple reproduction of the same insert feature may take place and, and on the other hand additional insert features from other sources may be stored and prepared for reproduction.

For the reproduction of additional insert features of this kind, advantageously a device for introducing the additional insert features is provided.

If, in addition, a device for the recognition of the reproduced signals is provided, which is connected to the device for introducing additional insert features, the introduction of specific insert features will take place in dependence on the signal. In this way, for example, it is possible to play features on certain products immediately after the appearance of these products during a film.

If a database for storing the types and numbers of the reproduced insert features is provided, a statistical evaluation of the reproduced data may take place, and billing of the providers of the insert features may be based thereon.

The invention will be further described with reference to examples of embodiments shown in the drawings to which, however, the invention is not restricted.

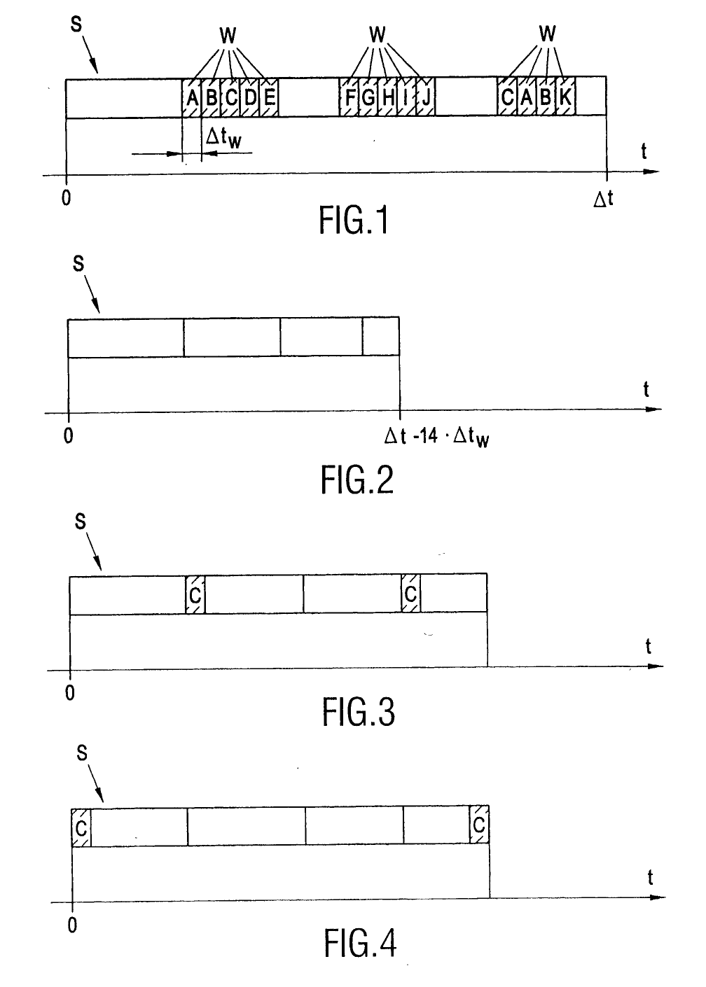

FIGS. 1 and 2 are schematic block diagrams of a signal in dependence on the time, which signal contains a certain number of different insert features.

FIG. 2 is a schematic block diagram of a signal in which the recognized insert features were automatically skipped.

FIGS. 3 to 7 are schematic block diagrams of signals in which certain insert features are selectively skipped in accordance with different modifications of the invention.

FIGS. 8 and 9 are schematic diagrams of a section of a signal in which the repetitions after insert features are recognized and skipped.

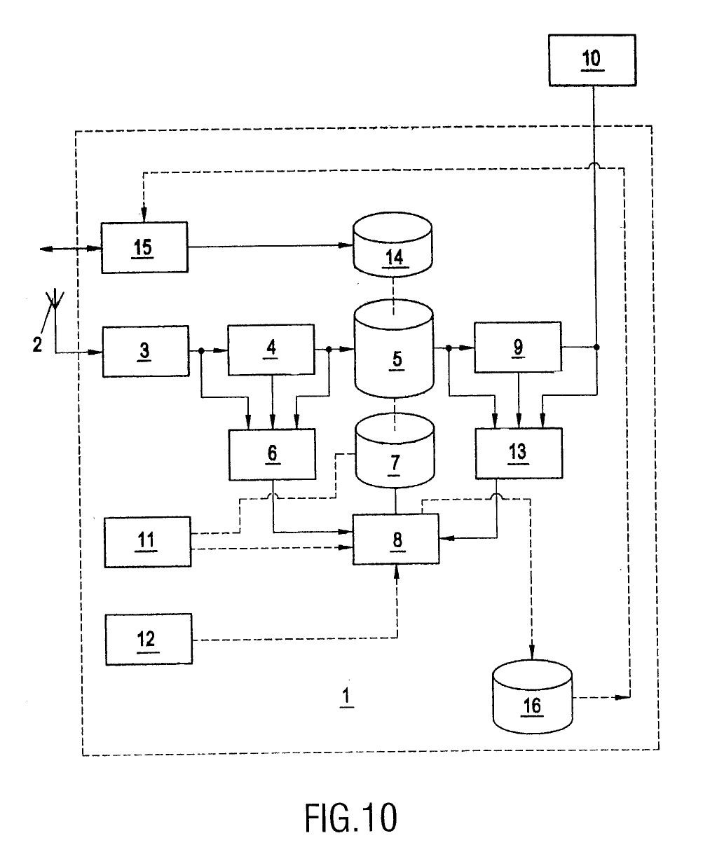

FIG. 10 is a schematic block diagram of a recording and reproduction device in accordance with the invention.

FIG. 1 is a schematic block diagram of a signal S as a function of time t. The signal S, for example a video signal, begins at a certain time t=0 and ends after a certain duration Δt. The signal contains a certain number of insert features W, which are usually summarized in the form of blocks which are played during the reproduction of the signal. The insert features usually have a given duration Δt_{W} which, for example with television commercial inserts, is usually 20 s. The insert features W in a block usually differ, and this was marked by the reference symbols A-K. Naturally, the insert features W may also be arranged several times during the reproduction of a signal S, as shown for examples C, A and B, which occur twice in the signal S.

FIG. 2 is a schematic block diagram of a signal S in which the insert features W were recognized and skipped. Correspondingly, the duration of the signal S is reduced by the duration of the skipped insert features W. In the example shown in FIG. 1, these would be 14 time slots of the insert features W, therefore the duration of the signal is Δt-14. Δt_{W}.

FIG. 3 shows a modification of the method according to the invention, with the insert features C being assigned suitable parameters which prevent the skipping of these insert features C during the reproduction of the signal S. Correspondingly, during the reproduction of the signal S, the insert features C are reproduced, whereas the other insert features A, B, D-K are skipped. This case occurs, for example, if the manufacturer of the insert features C provides financial support to the television station broadcasting the signal S or subsidizes the development of a recording and reproduction device of this kind. Therefore, the manufacturer of the insert feature C obviously has an interest in his insert features actually being reproduced for the end user and achieving a benefit.

FIG. 4 shows a modification of the method of FIG. 3, in which the insert features C are stored temporarily and reproduced at another time, here at the beginning and end of the signal S. This prevents, for example, the film being interrupted by the insert features C.

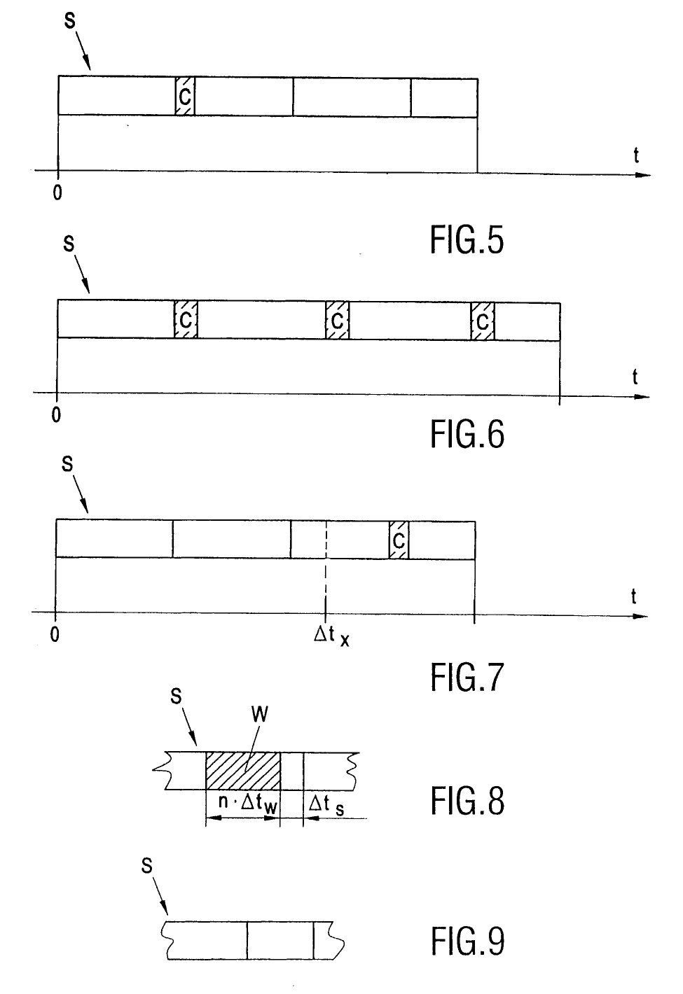

FIG. 5 shows a variant of the method according to the invention in which the number of reproductions of the flagged insert feature C is reduced and this insert feature C is only reproduced once.

With the modification FIG. 6, by contrast, the number of the insert features C is increased to three, for example.

FIG. 7 shows a modification in which the permissible insert features C are only permitted after a given playing duration Δt_{X}, so that the example shown only contains one insert feature C in the signal S.

FIG. 8 diagrammatically shows part of a signal S containing insert features with a duration of n.Δt_{W}. Usually after insert features W of this kind, parts of the signal S with a duration of Δt_{S} are repeated in order to guarantee the coherence of the signal. In the method according to the invention, signals of this type S, which are repeated in insert features W, are recognized and skipped similarly to the insert features W, resulting in the signal S of FIG. 9, in which the complete and repetition-free reproduction of the pure signal S, for example a feature film, is guaranteed.

FIG. 10 is a schematic block diagram of a recording and reproduction device 1 in accordance with the invention, which is formed, for example, by means of a video recorder, a DVD recorder, or a hard disk recorder. The video signal originating from an antenna 2, a cable, or the like goes into an input circuit 3 which may formed, for example, by analog or digital tuners or by a suitable internet interface. The signal may then go to a device 4 for data reduction before being stored in a storage device 5. Before, after, or after each internal functional block in the device 4 for data reduction, the signal goes to a device 6 for the recognition of the insert features W contained in the signal S. Stored in a further storage device 7, which may, obviously be integral with the storage device 5, are parameters which may be assigned to certain insert features and which, after the recognition of the insert features W in the recognition device 6, are checked in a checking and control unit 8. Depending upon the result of the checking in the checking and control unit 8, the reproduction of the signal S or the skipping or insertion of recognized insert features W is initiated by the checking and control unit 8. From the output circuit 9, which may be formed by a decoder, the signal passed on, for example, to a display device 10 such as, for example, a television set. An input device 11 may be used to change or enter the parameters stored in the storage device 7 for the recognition unit 6, the checking and control unit 8, and the output circuit 9. In addition, a time unit 12 may be provided which is connected to the checking and control unit 8 for skipping the recognized insert features W.

In addition, a device 13 for the recognition of signal sections preceding the insert features W and repeated after the insert features W and a device for the automatic skipping of these recognized signal sections Δt_{S} during the reproduction may be provided, which devices may be embodied by the checking and control unit 8 for skipping the recognized insert features W. The recognition devices 6 and 13 for the recognition of the insert features W and the signal sections Δt_{S} may be formed by image recognition devices or audio recognition devices or data evaluation devices. The recognition devices 6 and 13 may also be combined, in which case the signal paths have to be switched over in a suitable way. The preparation of the sequence of the desired signal S and wholly or partially unwanted insert features W and the blending out of repeat sequences may take place during the recording, during the reproduction, or during times when the device is not in use (standby mode). For the intermediate storage of insert features W, an independent storage device 14 different from the storage devices 5 and 7 may be provided, which may also be supplied with insert features W from other sources, for example from the Internet. It is also possible to store preprogrammed advertizing contents during manufacture of the device. A diagram of a device of this type for playing additional insert features W stored in the storage device 14 is represented by block 15. In order to ensure that the introduction of additional insert features W takes place in dependence on certain scenes in the signal S, a device for the recognition of the signals S may be provided, which may be implemented by the device 6 or the device 13 for the automatic recognition of the insert features. In addition, a database 16 for storing the types and numbers of the reproduced insert features W may be provided. The evaluation of the databank 16 may be used to build up a credit at the customer's or as a settlement for further services. The storage devices 5, 7, 14, and 16 may be integrated into one storage device.

It may be mentioned that the parameters assigned to the insert features may already be stored in the manufacturing stage of a recording and reproduction device, for example in a ROM (read only memory). Similarly, parameters of this kind may be received by the recording and reproduction device via one of its connections (antenna connection, Internet connection, telephone connection) and stored in the device.

It may be mentioned that a recording and reproduction device according to the invention may also be designed so as to insert a short repetition with a duration of Δt_{S} of the last signal reproduced, after a commercial insert device inserted by the device has been played.

1. A method of recording and reproducing signals, in particular video signals with insert features, in particular commercial insert features, wherein the insert features are automatically recognized, and parameters are assigned to the recognized insert features on the basis of which the insert features are selectively skipped.

2. A method as claimed in claim 1, wherein the parameters assigned to the recognized insert features can be modified.

3. A method as claimed in claim 1, wherein the selective skipping of the insert features takes place in dependence on the current time.

4. A method as claimed in claim 1, wherein the selective skipping of the insert features takes place in dependence on the relative time of the reproduction.

5. A method as claimed in claim 1, wherein any repetitions of sections of the signals recorded or reproduced before the insert features are automatically skipped together with these insert features after these insert features.

6. A method as claimed in claim 1, wherein the automatic recognition of the insert features takes place during the recording of the signals.

7. A method as claimed in claim 1, wherein the automatic recognition of the insert features takes place by means of image recognition.

8. A method as claimed in claim 1, wherein the automatic recognition of the insert features takes place by means of evaluation of the audio signal.

9. A method as claimed in claim 1, wherein the automatic recognition of the insert features takes place by means of data evaluation.

10. A method as claimed in claim 1, wherein the automatic recognition of the insert features takes place by recognition of an identification linked with the insert features.

11. A method as claimed in claim 1, wherein the selectively skipped insert features are stored temporarily and reproduced at some other time.

12. A method as claimed in claim 1, wherein additional insert features are played during the reproduction of the signals.

13. A method as claimed in claim 12, wherein the playing of the additional insert features takes place in dependence on the reproduced signals.

14. A method as claimed in claim 12, wherein the additional insert features can be modified.

15. A method as claimed in claim 1, wherein the numbers and types of the insert features and any additional insert features are detected and stored during the reproduction of the signals.

16. A recording and reproduction device (1) for signals (S), in particular for video signals, with insert features (W), in particular commercial insert features, with at least one storage device (5) for the signals (S) and insert features (W) and at least one device (6) for the automatic recognition of the insert features (W), and furthermore with a storage device (7) for parameters which may be assigned to certain insert features (W), with a checking and control unit (8) for checking the parameters assigned to the recognized insert features (W), and with a device (9) for an automatic selective skipping of those recognized insert features (W) to which certain parameters are assigned.

17. A recording and reproduction device (1) as claimed in claim 16, wherein an input device (11) is provided for inputting the parameters.

18. A recording and reproduction device as claimed in claim 16, wherein a time unit (12) is provided which is connected to the checking and control unit (8) for skipping the recognized insert features (W).

19. A recording and reproduction device as claimed in claim 16, wherein a device (13) for the recognition of those signal sections (Δtₛ) before the insert features (W) which are repeated after the insert features (W) and a device for the automatic skipping of these recognized signal sections (Δt_{S}) are provided.

20. A recording and reproduction device as claimed in claim 16, wherein the recognition devices (6, 13) are formed by image recognition devices.

21. A recording and reproduction device as claimed in claim 16, wherein the recognition devices (6, 13) are formed by audio recognition devices.

22. A recording and reproduction device as claimed in claim 15, wherein the recognition devices (6, 13) are formed by data evaluation devices.

23. A recording and reproduction device as claimed in claim 16, wherein a storage device (14) for the intermediate storage of insert features (W) is provided.

24. A recording and reproduction device as claimed in claim 16, wherein a device (15) for playing additional insert features (W) is provided.

25. A recording and reproduction device as claimed in claim 24, wherein a device for the recognition of the reproduced signals is provided which is connected to the device (15) for playing additional insert features.

26. A recording and reproduction device as claimed in claim 16, wherein a database (16) is provided for storing the types and numbers of the reproduced insert features (W).
